(19) United States
(12) Patent Application Publication
(10) Pub. No.: US 2010/0111827 A1
(43) Pub. Date: May 6, 2010

(54) PRODUCTION PROCESS FOR NOx ADSORPTION MATERIAL AND NOx ADSORPTION MATERIAL

(76) Inventor: Takaaki Kanazawa, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/596,480

(22) PCT Filed: Apr. 17, 2008
(86) PCT No.: PCT/JP2008/057513

§ 371 Date: Oct. 19, 2009

(30) Foreign Application Priority Data
Apr. 20, 2007 (JP) 2007-112081

(51) Int. Cl. C01B 39/06

(52) U.S. Cl. 423/700

(57) ABSTRACT

A zeolite is impregnated with a ferric chloride aqueous solution; and thereafter it is heated at 500° C.-700° C. in an atmosphere that is free from moisture, thereby subjecting Fe to ion exchange. By means of heating it in an atmosphere that is free from moisture, it is possible to produce an NOₓ adsorption material that demonstrates NOₓ adsorbing performance even after a hydrothermal durability test.

### TECHNICAL FIELD

The present invention relates to an NOₓ adsorption material that is used for converting the exhaust gases of automobile, and to a production process for the same.

### BACKGROUND ART

As a catalyst for converting exhaust gas, catalyst which is for lean-burn engine, an NOₓ storage-and-reduction type catalyst has been used, NOₓ storage-and-reduction type catalyst which includes a noble metal and an NOₓ storage material. This NOₓ storage-and-reduction type catalyst stores NOₓ into the NOₓ storage material in lean atmosphere, and converts NOₓ, which have been released from the NOₓ storage material at the time of rich spiking, by reduction by means of reducing components, such as HC, which exist abundantly in the atmosphere.

However, in the NOₓ storage-and-reduction type catalyst, it is difficult to store NOₓ in low-temperature region like at the time of starting up, and so forth, and accordingly there has been such a drawback that NOₓ have been discharged in the low-temperature region. Hence, it has been thought of using an NOₓ adsorption material that is capable adsorbing NOₓ in the low-temperature region, and an exhaust-gas converting apparatus, in which an NOₓ adsorption material is put in place on the upstream side of an NOₓ storage-and-reduction type catalyst, is proposed in Japanese Unexamined Patent Publication (KOKAI) Gazette No. 2001-289,035, for instance.

As for the NOₓ adsorption material, the oxides of alkali metals, the oxides of alkaline-earth metals, transition-metal oxides, such as CO₃O₄, NiO₂, MnO₂, Fe₂O₃ and ZrO₂, and zeolite are exemplified in the aforementioned gazette. Moreover, in Japanese Unexamined Patent Publication (KOKAI) Gazette No. 7-163,871, an NOₓ adsorption material is disclosed, NOₓ adsorption material which comprises CeO₂ and zeolite; and, in Japanese Unexamined Patent Publication (KOKAI) Gazette No. 2005-514,551, an NOₓ adsorption material is disclosed, NOₓ adsorption material which comprises zeolite that is ion exchanged with a base metal, such as Fe, Cu and Mn.

Patent Literature No. 1: Japanese Unexamined Patent Publication (KOKAI) Gazette No. 2001-289,035;

Patent Literature No. 2: Japanese Unexamined Patent Publication (KOKAI) Gazette No. 7-163,871; and

Patent Literature No. 3: Japanese Unexamined Patent Publication (KOKAI) Gazette No. 2005-514,551

### DISCLOSURE OF THE INVENTION

### Assignment to be Solved by the Invention

As a result of studying various NOₓ adsorption materials, the inventors of the present application found out that an NOₓ adsorption material, which is completed by ion exchanging zeolite with Fe, exhibits high NOₓ adsorbing capacity in low-temperature region. And, according to a liquid-phase exchanging method that uses an aqueous solution of water-soluble Fe salt, although the amount of ion exchanged Fe is less so that it is difficult to demonstrate desirable characteristics, it became apparent that a great amount of Fe can be ion exchanged by using a gas-phase exchanging method, which utilizes the sublimation of ferric chloride, and thereby an NOₓ adsorption material that is good in terms of NOₓ adsorbing characteristic is obtainable.

According to the gas-phase exchanging method utilizing the sublimation of ferric chloride, a zeolite powder is impregnated with an FeCl₃ aqueous solution, and thereafter FeCl₃ is vaporized by heating it to 330° C. or more, the sublimation temperature of FeCl₃ or more. The vaporized FeCl₃ goes into the pores of zeolite, and is then supported on the cation exchange sites by means of ion exchange.

However, as a result of studying NOₓ adsorption materials that were produced by the vapor-phase exchanging method in more detail, it became apparent that the resulting NOₓ adsorbing performance lowers greatly after a hydrothermal durability test.

The present invention is one which has been done in view of the aforementioned circumstances, and it is an assignment to be solved to make it into an NOₓ adsorption material that has high NOₓ adsorbing performance even after a hydrothermal durability test.

### Means for Solving the Assignment

A characteristic of a production process according to the present invention lies in that:

an impregnating step of impregnating a zeolite having cation exchange sites with a ferric chloride aqueous solution, thereby turning it into a ferric chloride-containing zeolite; and

an ion exchanging step of heating the ferric chloride-containing zeolite at 500° C.-700° C. in an atmosphere that is free from moisture, thereby subjecting Fe to ion exchange; are carried out in this order.

### Effect of the Invention

In accordance with the production process for NOₓ adsorption material according to the present invention, it is surely possible to stably produce an NOₓ adsorption material that demonstrates high NOₓ adsorbing performance even after a hydrothermal durability test, and that is good in terms of durability.

### BRIEF DESCRIPTION OF THE DRAWINGS

FIG. 1 is a graph for illustrating the NO adsorption amounts of NOₓ adsorption materials according to examples and comparative examples at their initial stages;

FIG. 2 is a graph for illustrating the NO adsorption amounts of the NOₓ adsorption materials according to the examples and comparative examples after undergoing a hydrothermal durability test at 300° C.;

FIG. 3 is a graph for illustrating the NO adsorption amounts of the NOₓ adsorption materials according to the examples and comparative examples after undergoing a hydrothermal durability test at 400° C.;

FIG. 4 is a graph for illustrating the NO adsorption amounts of the NOₓ adsorption materials according to the examples and comparative examples after undergoing a hydrothermal durability test at 500° C.;

FIG. 5 is a graph for illustrating the NO adsorption amounts of the NOₓ adsorption materials according to the examples and comparative examples after undergoing a hydrothermal durability test at 600° C.;

FIG. 6 is a graph for illustrating the NO adsorption amounts of the NOₓ adsorption materials according to the examples and comparative examples after undergoing a hydrothermal durability test at 700° C.;

FIG. 7 is a graph for illustrating the NO adsorption amounts of the NOₓ adsorption materials according to the examples and comparative examples after undergoing a hydrothermal durability test at 800° C.;

FIG. 8 is a graph for illustrating the NO adsorption amounts of the NOₓ adsorption materials according to the examples and comparative examples after undergoing a hydrothermal durability test at 900° C.; and

FIG. 9 is a graph for illustrating the NO adsorption amounts of NOₓ adsorption materials according to reference examples at their initial stages, and those after undergoing a hydrothermal durability test at 400° C.

### BEST MODE FOR CARRYING OUT THE INVENTION

As for a zeolite having cation exchange sites, although ZSM-5, mordenite, β-zeolite, type Y zeolite, type L zeolite, and the like, have been known, it become apparent that, in the zeolites other than mordenite, the hydrothermal durability of NOₓ adsorption materials, which are obtained by subjecting Fe to ion exchange by means of the aforementioned process, is not sufficient.

Hence, it is an assignment of a production process for NOₓ adsorption material according to the present invention, even when the zeolites other than mordenite are used, to adapt them into NOₓ adsorption materials that are good in terms of durability. In the present invention, it is possible to use ZSM-5, type Y zeolite and type L zeolite as the zeolite, and it is naturally possible to use mordenite, too.

In the production process according to the present invention, a ferric chloride-containing zeolite is prepared first of all by impregnating a zeolite having cation exchange sites with an FeCl₃ aqueous solution. It is feasible to subject Fe to ion exchange to a certain extent even by a method in which an FeCl₃ powder is sublimed after mixing the FeCl₃ powder with a zeolite powder physically. However, since the ion-exchange rate is low so that FeCl₃ escaping to the outside becomes greater, a method of impregnating it with an aqueous solution has been employed.

As for an impregnation amount of FeCl₃, it is desirable to impregnate a zeolite with it in an amount of the same mole as that of the Al atoms in the zeolite or more. This is because of the fact that, in a zeolite, ion exchange sites exist in an amount of the same number as the number of Al atoms, and accordingly the resulting NOₓ adsorbing performance improves the most in the case where all of them are ion exchanged with Fe.

Therefore, since it is preferable to use those with a great amount of cation exchange sites for a zeolite, it is desirable to use those whose SiO₂/Al₂O₃ molar ratio is 200 or less therefor. Moreover, although it is possible to use type H and type NH₄ zeolites, it is preferable to use a type NH₄ that is good in terms of ion exchanging property in the case of utilizing a vapor-phase exchanging method that uses FeCl₃.

At the ion exchanging step, the ferric chloride-containing zeolite is heated at 500° C.-700° C. in an atmosphere that is free from moisture, and thereby Fe is subjected to ion exchange. Even when using a zeolite such as ZSM-5, it is possible to produce an NOₓ adsorption material, which demonstrates high NOₓ adsorbing performance even after a hydrothermal durability test, by thus heating the ferric chloride-containing zeolite at high temperatures in an atmosphere that is free from moisture. When the heating temperature in the ion exchanging step is less than 500° C., the hydrothermal durability of the NOₓ adsorbing performance in the obtained NOₓ adsorption materials declines. Moreover, even when heating it beyond 700° C., the hydrothermal durability of the NOₓ adsorbing performance declines, though the reason has been unclear.

It is adapted herein into an atmosphere that is free from moisture, because the resulting NOₓ adsorbing performance declines when it is heated in an atmosphere that contains moisture; and it is believed to result from the fact that the degradation by means of aluminum elimination has been facilitated.

### Examples

Hereinafter, the present invention will be explained in detail by means of examples and comparative examples.

### Example No. 1

NH₄-ZSM-5 whose SiO₂/Al₂O₃ molar ratio was 28 was made ready, and was then impregnated within an FeCl₃ aqueous solution in such a charging amount that the Fe atoms made 1:1 with respect to the Al atoms. After evaporating this to dryness by heating it at 120° C., it was then heated to 500° C. by an electric furnace in an atmosphere that was free from moisture, and was held thereat for 5 hours. By means of this, FeCl₃ sublimed to vaporize, and thereby almost all of the cation exchange sites of the ZSM-5 were ion exchanged with Fe.

### Example No. 2

The same zeolite as that of Example No. 1 was used; was ion exchanged with Fe similarly; and thereafter the ion exchanging step was carried out in the same manner as Example No. 1, except that the heating temperature was adapted into being 600° C.

### Example No. 3

The same zeolite as that of Example No. 1 was used; was ion exchanged with Fe similarly; and thereafter the ion exchanging step was carried out in the same manner as Example No. 1, except that the heating temperature was adapted into being 700° C.

### Comparative Example No. 1

The same zeolite as that of Example No. 1 was used; was ion exchanged with Fe similarly; and thereafter the ion exchanging step was carried out in the same manner as Example No. 1, except that the heating temperature was adapted into being 400° C.

### Comparative Example No. 2

The same zeolite as that of Example No. 1 was used; was ion exchanged with Fe similarly; and thereafter the ion exchanging step was carried out in the same manner as Example No. 1, except that the heating temperature was adapted into being 800° C.

### Comparative Example No. 3

The same zeolite as that of Example No. 1 was used; was ion exchanged with Fe similarly; and thereafter the ion exchanging step was carried out in the same manner as Example No. 1, except that the heating temperature was adapted into being 900° C.

### Testing Example No. 1

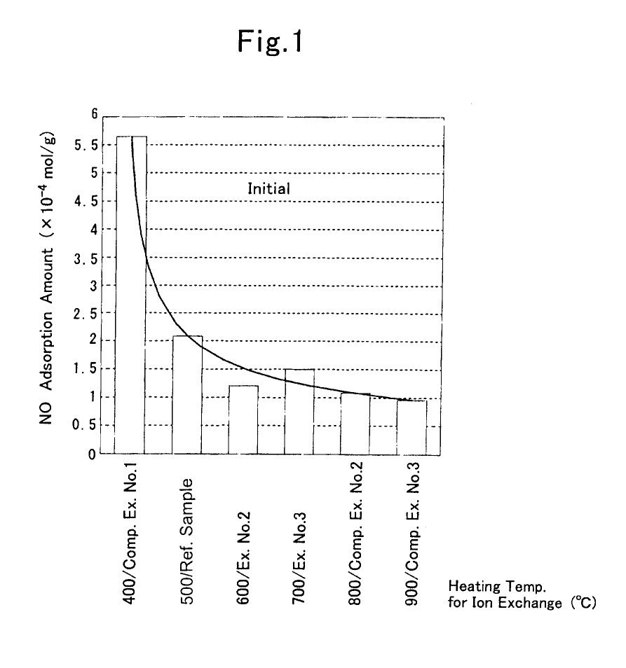

The NOₓ adsorption materials according to the respective examples and respective comparative examples were pelletized by an ordinary method, respectively, and were then offered for testing. Each of the pellets was charged into an evaluating apparatus in a predetermined amount; first of all, a model gas given in Table 1 was distributed at a temperature of 50° C. in a flow volume of 10 L/min. for 8 minutes; and the adsorption amounts of NO (initial NO adsorption amounts) that had been adsorbed during the period were measured, respectively. The results are illustrated in FIG. 1.

Next, regarding the respective NOₓ adsorption materials, a hydrothermal durability test was carried out, hydrothermal durability test in which they were held at 300° C., 400° C., 500° C., 600° C., 700° C., 800° C. and 900° C., respectively, for 5 hours in atmospheres in which an N₂ gas, which included 10% H₂O and 2% CO, and another N₂ gas, which included 2% O₂, were flowed while switching them alternately for 5 minutes each.

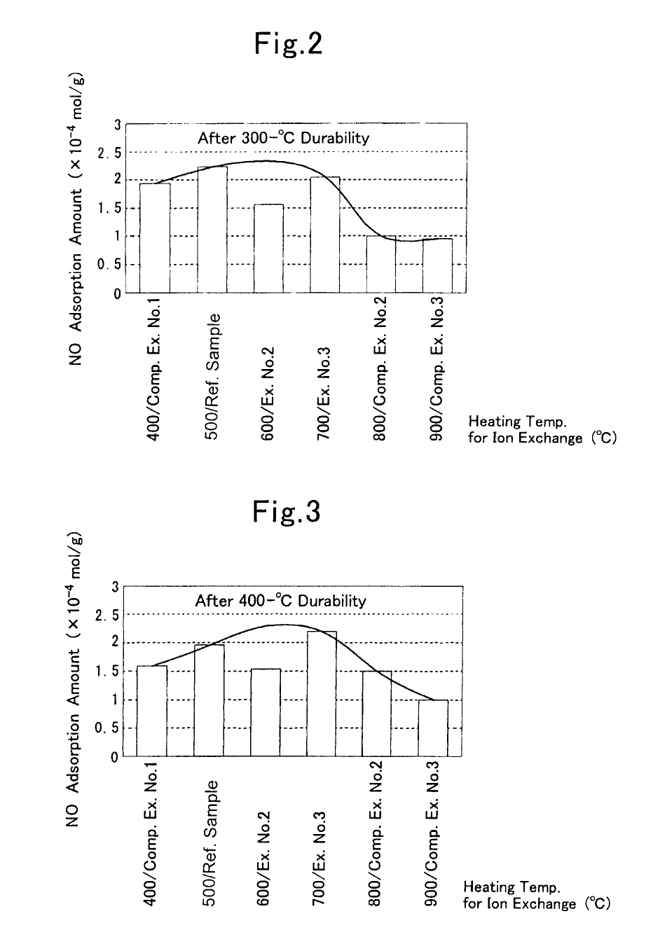

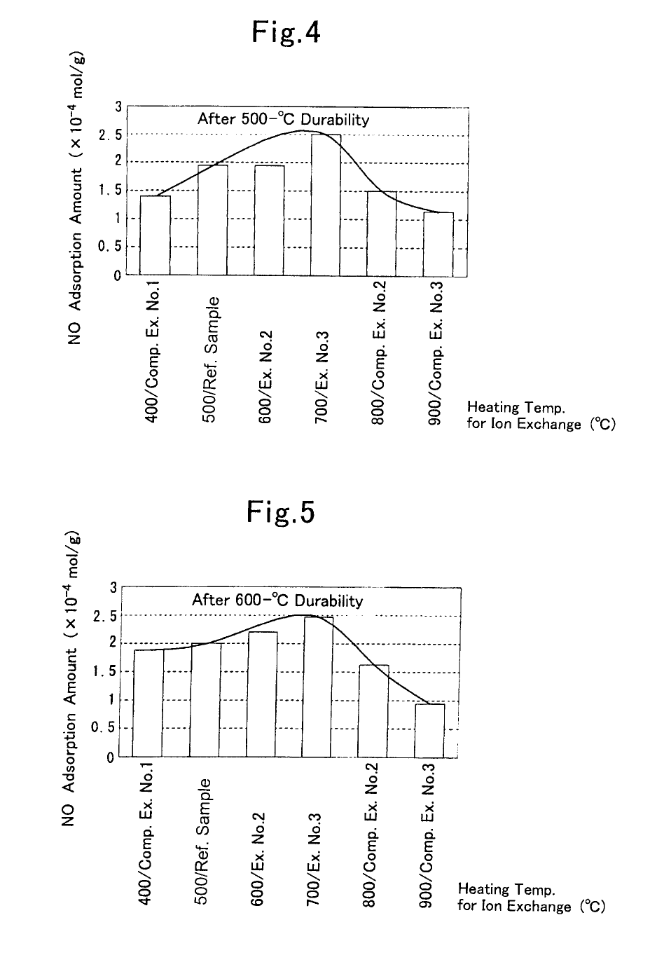

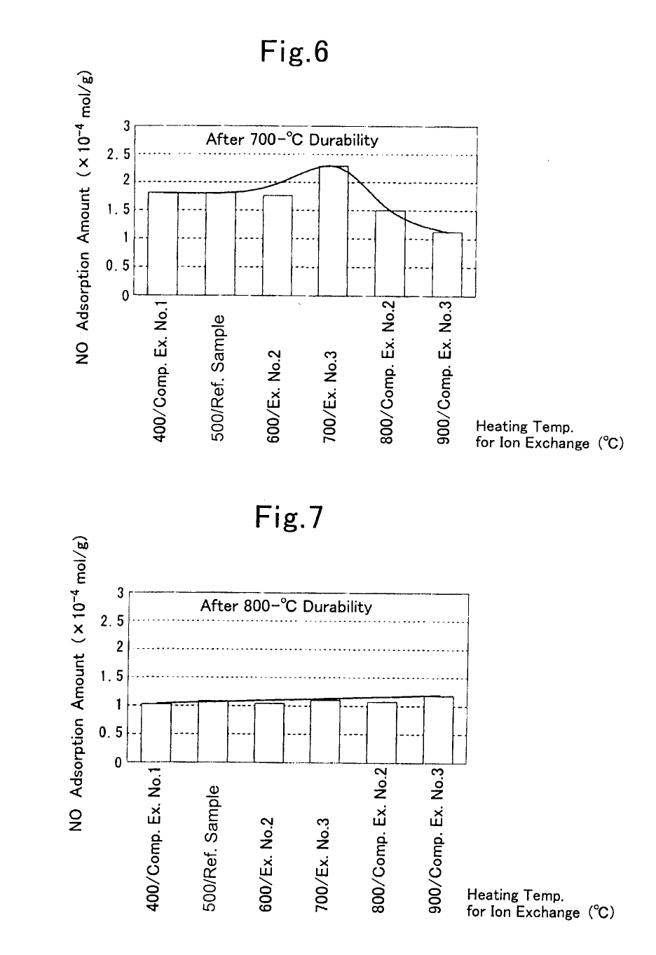

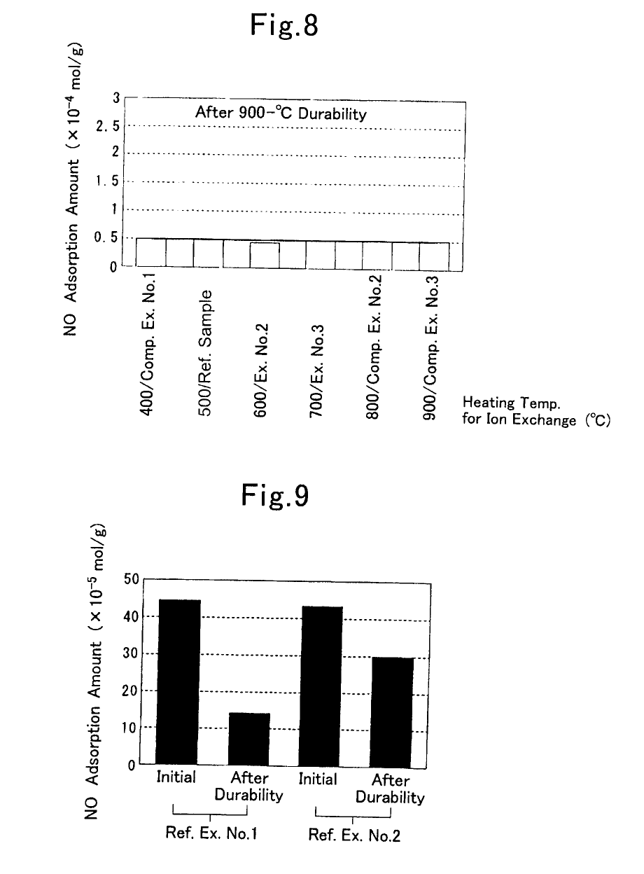

After doing purging by distributing a 500-° C. N₂ gas with respect to the respective NOₓ adsorption materials after the hydrothermal durability test, the model gas given in Table 1 was distributed at a temperature of 50° C. in a flow volume of 10 L/min. for 8 minutes, and the adsorption amounts of NO that had been adsorbed during the period were measured, respectively. The results are illustrated in FIG. 2 through FIG. 8.

TABLE 1

| NO | CO | CO₂ | |
|---|---|---|---|
| (ppm) | (ppm) | (%) | N₂ |
| 900 | 6000 | 15 | Balance |

From FIG. 2-FIG. 8, in accordance with the NOₓ adsorption materials according to Example Nos. 1-3 that were subjected to the ion-exchange processing at 500° C.-700° C., it is apparent that their high NOₓ adsorbing performance was maintained even after the hydrothermal durability test at 300° C.-700° C.

Moreover, from FIG. 1, it is understood that the lower the heating temperature at the time of ion exchanging the higher the initial NO adsorption amount was, and that, considering the initial NOₓ adsorbing performance alone, the heating at 400° C. like Comparative Example No. 1 can be the most preferable. However, in Comparative Example No. 1, the NO adsorption amount was declined less than the initial value by carrying out the hydrothermal durability test at 500° C.-700° C.; whereas, in the NOₓ adsorption material according to Example No. 1, it was equivalent to the initial value substantially; and, in the NOₓ adsorption materials according to Example Nos. 2-3, their NO adsorption amounts were augmented contrarily.

Specifically, taking the durability of NOₓ adsorbing performance at the time of service into consideration, it is apparent that it is desirable to do the ion-exchange processing at 500° C.-700° C.

### Reference Example No. 1

NH₄-ZSM-5 whose SiO₂/Al₂O₃ molar ratio was 28 was made ready in an amount of 20 g, and was then impregnated within an aqueous solution in which anhydrous FeCl₃ was dissolved in an amount of 3.4 g. After evaporating this to dryness by heating it at 120° C., it was then heated to 400° C. by an electric furnace in an atmosphere that was free from moisture, and was held thereat for 5 hours. By means of this, FeCl₃ sublimed to vaporize, and thereby almost all of the cation exchange sites of the ZSM-5 were ion exchanged with Fe.

### Reference Example No. 2

Instead of the ZSM-5, an H-mordenite powder whose SiO₂/Al₂O₃ molar ratio was 28 was made ready, and Fe was subjected to ion exchange in the same manner as Reference Example No. 1.

### Testing Example No. 2

The NOₓ adsorption materials according to Reference Example Nos. 1 and 2 were pelletized by an ordinary method, respectively, and were then offered for testing. Each of the pellets was charged into an evaluating apparatus in a predetermined amount; first of all, the adsorption amounts of NO were measured in the same manner as Testing Example No. 1. Subsequently, the same hydrothermal durability test as that in Testing Example No. 1 was carried out, thereby measuring the NO adsorption amounts after the hydrothermal durability test. The results are illustrated in FIG. 9.

From FIG. 9, although the NOₓ adsorption material according to Reference Example No. 1 using the ZSM-5 exhibited an NO adsorption amount, which was equivalent to that of the NOₓ adsorption material according to Reference Example No. 2 using the mordenite, at the initial stage, the NO adsorption amount declined greatly after the hydrothermal durability test. Specifically, it is apparent that the NOₓ adsorption material according to Reference Example No. 1 using the ZSM-5 was poor in terms of durability, compared with that of the NOₓ adsorption material according to Reference Example No. 2 using the mordenite, when it underwent the ion-exchange processing in which it was heated to 400° C., and therefore the usefulness of the present invention becomes apparent by taking the aforementioned examples into account.

### INDUSTRIAL APPLICABILITY

In addition to putting the NOₓ adsorption material according to the present invention in place on the exhaust-gas upstream side of NOₓ storage-and-reduction type catalyst to use, it is also feasible to use it independently.

1. A production process for NOₓ adsorption material, wherein:
an impregnating step of impregnating a zeolite having cation exchange sites with a ferric chloride aqueous solution, thereby turning it into a ferric chloride-containing zeolite; and
an ion exchanging step of heating the ferric chloride-containing zeolite at 600° C.-700° C. in an atmosphere that is free from moisture, thereby subjecting Fe to ion exchange; are carried out in this order.

2. The production process for NOₓ adsorption material as set forth in claim 1, wherein said zeolite is ZSM-5.

3. An NOₓ adsorption material that is produced by the production process as set forth in claim 1.

4. An NOₓ adsorption material that is produced by the production process as set forth in claim 2.
